(19) United States
(12) Patent Application Publication
(10) Pub. No.: US 2025/0121336 A1
(43) Pub. Date: Apr. 17, 2025

(54) MICRO BUBBLE GENERATING MECHANISM

(71) Applicant: THERMOS (JIANGSU) HOUSEWARES CO., LTD., Huaian (CN)

(72) Inventors: Tachun LIU, Huaian (CN); Jun ZHOU, Huaian (CN)

(21) Appl. No.: 18/829,704

(22) Filed: Sep. 10, 2024

(30) Foreign Application Priority Data
Oct. 12, 2023 (CN) 202311321184.7

(51) Int. Cl. B01F 23/2375; B01F 23/232; B01F 23/233; B01F 23/80; B01F 25/452; B01F 27/1125; B01F 101/17

(52) U.S. Cl. CPC B01F 23/2375; B01F 23/232; B01F 23/233; B01F 23/805; B01F 25/4521; B01F 25/4523; B01F 27/11251; B01F 2101/17

(57) ABSTRACT

The invention discloses a novel micro bubble generating mechanism, and relates to the technical field of wine treatment, the novel micro bubble generating mechanism comprises a micro bubble generator body, a water molecule bubble generator, a high-speed rotating blade, an air pressure conversion mechanism and a high-grade stainless steel high-density gauze, one end of the micro bubble generator body is provided with an inlet, and from one end to the other end of the micro bubble generator body itself there is provided with in sequence the water molecule bubble generator, the air pressure conversion mechanism and the high-grade stainless steel high-density gauze. Through the arrangement of the micro bubble generating mechanism, a traditional decanting mode is broken.

### BACKGROUND OF THE INVENTION

### Field of the Invention

The present invention relates to the technical field of liquor treatment, in particular to a novel micro bubble generating mechanism.

### Description of the Related Art

At present, the red wine decanter on the market is too traditional, time-consuming and labor-intensive. There is a long wait to taste the delicious red wine. In the rhythm of the new era, a drinker can taste delicious red wine at any time, and the drinker is relaxed and comfortable.

The mode of decanting liquor in the prior art is that the liquor is placed in a liquor container, and then a rotation or swing mechanism is arranged at the bottom of the liquor container, so that the liquor container is driven to rotate or swing, so as to achieve the purpose of decanting. However, this decanting mode is time-consuming and labor-intensive, it is difficult to achieve rapid decanting, and the liquor after decanting is also difficult to enhance the experience sense of the drinker.

### SUMMARY OF THE INVENTION

The purpose of the invention is to provide a novel micro bubble generating mechanism, so as to solve the above mentioned technical issue.

The present invention adopts the following technical solution.

A novel micro bubble generating mechanism, comprising: a micro bubble generator body, a water molecule bubble generator, a high-speed rotating blade, an air pressure conversion mechanism and a high-grade stainless steel high-density gauze,
wherein one end of the micro bubble generator body is provided with an inlet, and from one end to the other end of the micro bubble generator body itself there is provided with in sequence the water molecule bubble generator, the air pressure conversion mechanism and the high-grade stainless steel high-density gauze, the high-speed rotating blade is arranged in the inner of the water molecule bubble generator, liquid enters from the inlet into the water molecule bubble generator to generate a lot of nanobubbles, and is sheared by the high-speed rotating blade to form a lot of micron-scale and nano-scale bubbles, and is electrolyzed to form free radical ions.

As preferred, one end of the water molecule bubble generator is adjacent to the inlet, and the other end of the water molecule bubble generator is connected to the air pressure conversion mechanism.

As further preferred, one end of the water molecule bubble generator is arranged in a funnel-shaped manner, and a plurality of liquid inlet holes are formed in the outer wall of one end of the water molecule bubble generator.

As preferred, a center shaft is arranged in the middle of the water molecule bubble generator, a plurality of high-speed rotating blades are arranged on the outer edge of the center shaft.

As further preferred, one end of each of the high-speed rotating blades, far away from one end of the center shaft, is arranged to be bent, and each of the high-speed rotating blades is a double-layer high-speed rotating blade.

As preferred, the micro bubble generator body comprises an upper portion and a lower portion connected to the upper portion, both the water molecule bubble generator and the air pressure conversion mechanism are arranged in the upper portion, and the high-grade stainless steel high-density gauze is arranged in the lower portion.

As preferred, a plurality of layers are arranged in the high-grade stainless steel high-density gauze.

The above technical solution has the following advantages or benefit effects:

In the present invention, through the arrangement of the micro bubble generating mechanism, a traditional decanting mode is broken, in the using process of a user, micro-nano water molecules are generated from the red wine bottle through the micro bubble generating mechanism, the micro-nano water molecules are fully fused with oxygen and enter the oral cavity, the activated small molecules collide with one another, the experience feeling of a drinker is greatly improved. The requirements of modernization and new times of life are met, the novelty of impact feeling in use is increased, the requirements of modern new consumption are met, and the comfort degree in use is improved.

### BRIEF DESCRIPTION OF THE DRAWINGS

FIG. 1 is a schematic diagram of the internal structure of the novel micro bubble generating mechanism in the present invention.

In the figure: 1, micro bubble generator body; 101, inlet; 102, upper portion; 103, lower portion; 2, water molecule bubble generator; 201, liquid inlet hole; 3, high-speed rotating blade; 301, round hole; 4, air pressure conversion mechanism; 5, high-grade stainless steel high-density gauze; 6, center shaft.

### DETAILED DESCRIPTION

The technical solution of the present invention will be clearly and completely described below in conjunction with the accompanying drawings, and it is obvious that the described embodiments are part of the embodiments of the present invention, not all embodiments. Based on the embodiments in the present invention, all other embodiments obtained by a person skilled in the art without making creative labor belong to the scope of protection of the present invention.

In the description of the present invention, it should be noted that if the terms “center,” “up,” “down,” “left,” “right,” “vertical,” “horizontal,” “inner,” “outer,” etc., appear, the orientation or positional relationship indicated by it is based on the orientation or positional relationship shown in the accompanying drawing, and is only for the convenience of describing the invention and simplifying the description, and does not indicate or imply that the device or element referred to must have a specific orientation, be constructed and operated in a specific orientation, and therefore cannot be understood as a limitation of the present invention. In addition, the terms “first”, “second”, “third” are used for descriptive purposes only and should not be construed as indicating or implying relative importance.

In the description of the present invention, it should be noted that, unless otherwise expressly specified and limited, the terms “mounted,” “connected,” “coupled” shall be understood broadly, for example, they may be fixed, detachable, or integrally connected; it can be mechanically or electrically connected; it can be directly connected or indirectly connected through an intermediate medium, or it can be a communication between two components. For those skilled in the art, the specific meaning of the above terms in the present invention can be understood on a case-by-case basis.

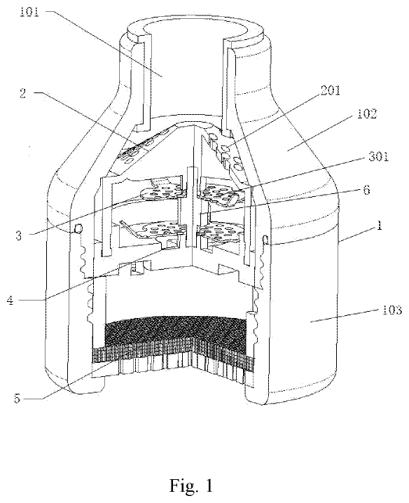

FIG. 1 is a schematic diagram of the internal structure of the novel micro bubble generating mechanism in the present invention. As shown in FIG. 1, there is provided a novel micro bubble generating mechanism, comprising: a micro bubble generator body 1, a water molecule bubble generator 2, a high-speed rotating blade 3, an air pressure conversion mechanism 4 and a high-grade stainless steel high-density gauze 5, wherein one end of the micro bubble generator body 1 is provided with an inlet 101, and from one end to the other end of the micro bubble generator body 1 itself there is provided with in sequence the water molecule bubble generator 2, the air pressure conversion mechanism 4 and the high-grade stainless steel high-density gauze 5, the high-speed rotating blade 3 is arranged in the inner of the water molecule bubble generator 2, liquid enters from the inlet 101 into the water molecule bubble generator 2 to generate a lot of nanobubbles, and is sheared by the high-speed rotating blade 3 to form a lot of micron-scale and nano-scale bubbles, and is electrolyzed to form free radical ions. In this embodiment, as shown in FIG. 1, the micro bubble generator body 1 comprises an upper portion 102 and a lower portion 103 connected to the upper portion 102, both the water molecule bubble generator 2 and the air pressure conversion mechanism 4 are arranged in the upper portion 102, and the high-grade stainless steel high-density gauze 5 is arranged in the lower portion 103. The upper portion 102 of the micro bubble generator body 1 is detachably connected to the lower portion 103 of the micro bubble generator body 1, so as to facilitate the installation. The upper portion 102 and the lower portion 103 are connected through a threaded connection, a seal ring is arranged between the upper portion 102 and the lower portion 103 so as to avoid the leak of the liquid.

One end of the water molecule bubble generator 2 is adjacent to the inlet 101, and the other end of the water molecule bubble generator 2 is connected to the air pressure conversion mechanism 4. Specifically, the other end of the water molecule bubble generator 2 is arranged with an opening, and the other end of the water molecule bubble generator 2 is clamped with the air pressure conversion mechanism 4, an annular sleeve is arranged in the lower portion 103, and the two ends of the annular sleeve rest against the air pressure conversion mechanism 4 and the high-grade stainless steel high-density gauze 5, so that the annular sleeve supports the air pressure conversion mechanism 4.

The novel micro bubble generating mechanism 1 in this embodiment is vertically arranged, and one end of the water molecule bubble generator 2 is upward, and the other end is downward, when the liquid (edible liquids such as red wine, white wine, water) enters the water molecule bubble generator 2 through the inlet 101, a lot of nanobubbles will be produced under the effect of the water molecule bubble generator 2, and a high-pressure area is formed around the bubble, so that the bubbles can rapidly expand to form a spherical space of a certain radius. After the liquid forms nano-scale bubbles, it enters the area of high-speed rotating blade 3, and the formed nano-scale bubble water flow will impact the high-speed rotating blade 3, so that the high-speed rotating blade 3 begins to rotate at high speed, and produces high-speed and powerful shearing and high-frequency pressure changes, forming artificial extreme conditions, generating a lot of micron-scale and nano-scale bubbles under this condition while having the effect of breaking the polymeric molecular group and forming small molecule groups of active water, and can ionize and decompose a small part of water molecules, and can produce free radical ions such as reactive oxygen, oxygen ions, hydrogen ions, and hydroxide ions in the micro-nano bubble space. The air pressure conversion mechanism 4 can form a high-pressure area of free radical ions produced by micron-scale and nano-scale bubbles, so that the bubbles accelerate expansion to form a spherical space of a certain radius.

In this embodiment, a plurality of layers, which are made of multi-layer steel material, are arranged in the high-grade stainless steel high-density gauze 5. High-density dense micropores are arranged on the surface of the high-grade stainless steel high-density gauze 5, and when the liquid water passes through the micropores, it will cause a high-strong shear force, activate and improve the activity of water molecules. The liquid acts and extrudes between the high-speed rotating blade 3 and the high-grade stainless steel high-density gauze 5, and the part of the liquid, which is micro-nano fine, flows out the high-grade stainless steel high-density gauze 5, and the part of the liquid, which is not micro-nano fine, flows through the round hole 301 arranged on the high-speed rotating blade 3, refluxes to the upper end, and it circulates, and extrudes again.

Further, as a preferred embodiment, one end of the water molecule bubble generator 2 is arranged in a funnel-shaped manner, and a plurality of liquid inlet holes 201 are formed in the outer wall of one end of the water molecule bubble generator. In this embodiment, as shown in FIG. 1, a funnel-shaped structure is arranged at the upper end of the water molecule bubble generator 2, and liquid inlet holes 201 are arranged in the outer wall of the funnel-shaped structure to facilitate the entry of the liquid. The upper end of the water molecule bubble generator 2 is arranged in a funnel-shaped, and the funnel-shaped is narrow at the top and wide at the bottom. The middle part of the upper end of the water molecule bubble generator 2 faces the middle part of the inlet 101, so that the entered liquid falls directly on the funnel-shaped structure, and under the effect of the slope of the side wall of the funnel-shaped structure, the flow rate of the liquid is slowed down, so that the liquid slowly enters the water molecule bubble generator 2, which is conducive to the generation of nanobubbles.

Further, as a preferred embodiment, a center shaft 6 is arranged in the middle of the water molecule bubble generator 2, a plurality of high-speed rotating blades 3 are arranged on the outer edge of the center shaft 6. In this embodiment, each of the high-speed rotating blades 3 is a double-layer high-speed rotating blade, which is convenient for increasing the contact area with the liquid.

Referring to FIG. 1, a round hole 301 is also arranged in the high-speed rotating blade 3, and the axis of the liquid inlet hole 201 on the side wall of the funnel-shaped structure at the upper end of the water molecule bubble generator 2 intersects with the axis of the round hole 301 at an acute angle, so that the liquid can be directly sprayed on the high-speed rotating blade 3 through the liquid inlet holes 201, and a part of the liquid is directly sprayed in the round hole 301. Because the axis of the round hole 301 intersects with the axis of the liquid inlet hole 201 at an acute angle, the liquid can provide the force of circumferential rotation for the high-speed rotating blade 3, and the high-speed rotation on the high-speed rotating blade 3 is conveniently realized.

Further, as a preferred embodiment, one end of each of the high-speed rotating blades 3, far away from one end of the center shaft 6, is arranged to be bent. In this embodiment, the end of the high-speed rotating blade 3 is bent upward, and the water flow that comes from the jet can impact the bending position of the high-speed rotating blade 3, so that the high-speed rotating blade 3 is further driven to rotate.

In the invention, a traditional decanting mode is broken, in the using process of a user, micro-nano water molecules are generated from the red wine bottle through the micro bubble generating mechanism, the micro-nano water molecules are fully fused with oxygen and enter the oral cavity, the activated small molecules collide with one another, the experience feeling of a drinker is greatly improved. The requirements of modernization and new times of life are met, the novelty of impact feeling in use is increased, the requirements of modern new consumption are met, and the comfort degree in use is improved.

The water molecule bubble generator 2 is a device that uses the principle of atmospheric pressure to produce a lot of micro-nano bubbles. When the water enters the inside of the microbubble booster generator through the inlet valve, a lot of micro-nano bubbles will be generated in the water, forming a high-pressure area around the bubbles, making the bubbles rapidly expand to form a spherical space of a certain radius, so that the water and gas are in full contact, so as to achieve gas-liquid mixing.

Micro-nano bubbles have the characteristics of slow rise rate and self-pressurized dissolution, which makes the micro-nano bubbles gradually shrink to nano-scale in the slow rising process, and finally dissolve into water with annihilation, so as to greatly improve the solubility of gases (air, oxygen, ozone, carbon dioxide, etc.) in liquids.

The gyratory gas-liquid mixed micro-nano bubble generation technology is a generator designed according to the structure of the hydrodynamic calculation, the gas-liquid mixed fluid entering the generator rotates at high speed under the action of pressure, and forms a negative pressure shaft in the middle of the generator, and the suction of the negative pressure shaft can concentrate the mixed gas in the liquid or the gas accessed externally on the negative pressure shaft. When the liquid and gas rotating at high speed are ejected from the specially designed nozzle under appropriate pressure, due to the mechanical multiplication effect of the ultra-high rotation speed of the gas-liquid mixture at the nozzle and the gas-liquid density ratio (1:1000), high-speed and strong shear and high-frequency pressure changes are generated between the gas-liquid contact interface, forming artificial extreme conditions, and at the same time, a lot of micron-scale and nano-scale bubbles are generated under this condition, and at the same time, it has the effect of breaking the polymerized molecular groups and forming small molecule groups of active water, and can ionize and decompose a small part of water molecules, which can produce free radical ions, such as reactive oxygen, oxygen ions, and hydrogen ions and hydroxide ions, in the micro-nano bubble space.

The above is only a preferred embodiment of the present invention, and does not intend to limit the embodiment and scope of protection of the present invention, and those skilled in the art should be able to realize that all solutions obtained by equivalent substitutions and obvious changes made by using the contents of the description and illustrations shall be included in the scope of protection of the present invention.

What is claimed is:

1. A novel micro bubble generating mechanism, comprising: a micro bubble generator body, a water molecule bubble generator, a high-speed rotating blade, an air pressure conversion mechanism and a high-grade stainless steel high-density gauze,
wherein one end of the micro bubble generator body is provided with an inlet, and from one end to the other end of the micro bubble generator body itself there is provided with in sequence the water molecule bubble generator, the air pressure conversion mechanism and the high-grade stainless steel high-density gauze, the high-speed rotating blade is arranged in the inner of the water molecule bubble generator, liquid enters from the inlet into the water molecule bubble generator to generate a lot of nanobubbles, and is sheared by the high-speed rotating blade to form a lot of micrometer bubbles and nanobubbles, and is electrolyzed to form free radical ions.

2. The novel micro bubble generating mechanism of claim 1, wherein one end of the water molecule bubble generator is adjacent to the inlet, and the other end of the water molecule bubble generator is connected to the air pressure conversion mechanism.

3. The novel micro bubble generating mechanism of claim 2, wherein one end of the water molecule bubble generator is arranged in a funnel-shaped manner, and a plurality of liquid inlet holes are formed in the outer wall of one end of the water molecule bubble generator.

4. The novel micro bubble generating mechanism of claim 1, wherein a center shaft is arranged in the middle of the water molecule bubble generator, a plurality of high-speed rotating blades are arranged on the outer edge of the center shaft.

5. The novel micro bubble generating mechanism of claim 4, wherein one end of each of the high-speed rotating blades, far away from one end of the center shaft, is arranged to be bent, and each of the high-speed rotating blades is a double-layer high-speed rotating blade.

6. The novel micro bubble generating mechanism of claim 1, wherein the micro bubble generator body comprises an upper portion and a lower portion connected to the upper portion, both the water molecule bubble generator and the air pressure conversion mechanism are arranged in the upper portion, and the high-grade stainless steel high-density gauze is arranged in the lower portion.

7. The novel micro bubble generating mechanism of claim 1, wherein a plurality of layers are arranged in the high-grade stainless steel high-density gauze.
